(19) United States
(12) Patent Application Publication
(10) Pub. No.: US 2015/0211662 A1
(43) Pub. Date: Jul. 30, 2015

(54) ADJUSTABLE FITTINGS FOR SMOOTH PIPE

(71) Applicant: Daniel Corcoran, Traverse City, MI (US)

(72) Inventor: Daniel Corcoran, Traverse City, MI (US)

(21) Appl. No.: 14/163,254

(22) Filed: Jan. 24, 2014

(51) Int. Cl. F16L 13/00; F16L 13/10; F16L 43/00; F16L 15/00; F16L 21/00

(52) U.S. Cl. CPC F16L 13/00; F16L 15/00; F16L 21/00; F16L 43/00; F16L 13/103; F16L 21/002

(57) ABSTRACT

Fittings for smooth surfaced pipe including an adjustable fitting in which the lateral wings of a saddle-shaped configuration can be molded to the surface of a round pipe using a hammering technique or a squeezing technique. The adjustable fitting is adhered to the pipe using a metal adhesive and optionally, dimpling in the pipe per se.

### BACKGROUND OF THE INVENTION

The invention herein disclosed deals with fittings for smooth surfaced pipe. Generally in the field of pipes and pipe fittings for pipe line assemblies that axe constructed for conveying fluids under pressure, there are used several different types of standard pipe including grooved, ridge, rolled, beaded, threaded and smooth, this typing indicating the configuration of the outer surface of the pipe that is adaptable to the various pipe couplings that are available to the industry.

The invention disclosed herein deals with adjustable fittings for smooth pipe systems.

### THE INVENTION

Thus, what is disclosed and claimed herein, in one embodiment, is an adjustable fitting for smooth pipe. The adjustable fitting comprises an integral combination of a malleable saddle-configured base having a linear axis, terminal ends, two lateral wings, a top surface and a centered opening therethrough.

There is a hollow hub centered and surmounted over the centered opening. The hollow hub has an inside surface and a bottom edge. In addition, there are two stabilizer ridges located on the top surface of the base. Each stabilizer ridge has a top flat surface, and extends along the linear axis of the saddle-configured base from the hub to a terminal end of the saddle-configured base.

In a second embodiment, there is a coupling for smooth pipe, the coupling being a hollow tube with a center point and the coupling has at least one concave dimple at the center point. The coupling has an inside diameter for accepting smooth pipe in a close, sliding fit.

Yet another embodiment is a smooth pipe elbow, the smooth pipe elbow having two ends and a circular wall extending therebetween. The smooth pipe elbow has at least one concave dimple in the wall at a predetermined distance from each end.

In addition, there is a further embodiment in which the combination of a coupling of this invention and smooth pipe are connected together with a metal adhesive.

Still another embodiment of this invention is a combination of at coupling as set forth Supra, smooth pipe, and an adjustable fitting, wherein the adjustable fitting comprises an integral combination of a saddle-configured base having a linear axis, terminal ends, two lateral wings, a top surface and a centered opening therethrough, a hollow hub centered and surmounted over the centered opening, the hollow hub having an inside surface and a bottom edge.

There are two stabiliser ridges located on the top surface of the base, each stabilizer ridge having a top flat surface, and extending along the linear axis of the saddle-configured base from the hub to a terminal end of the saddle-configured base, and, a means of connecting the coupling, the smooth pipe, and the adjustable fitting together.

Included herein is an embodiment which is a combination of a first smooth pipe and a pipe reducer, said first smooth pipe having two ends, an inside diameter, an outside diameter and an outside surface of the first smooth pipe having a concave dimple located near at least one end of the first smooth pipe, each dimple being located a predetermined distance from each end.

The pipe reducer has an outside surface, an outside diameter less than the inside diameter of the first smooth pipe and an inside diameter, being slidably acceptable into a second smooth pipe having a diameter less than the inside diameter of the first smooth pipe.

There is a second smooth pipe having an outside surface and being lesser in diameter than the first smooth pipe and slidably insertable into the pipe reducer, the second smooth pipe having a concave stop dimple located oh an outside surface a predetermined distance from an end of the second smooth pipe, these components being connected and fixed together by an adhesive.

Additionally included within the scope of this invention is a method of manufacturing the combinations as set forth Supra, the method comprising treating the outside surface of the reducer near one end with an adhesive; treating the outside surface of the second smooth pipe near one end with an adhesive; fitting the first smooth pipe, the reducer, and the second smooth pipe together; placing a securing concave dimple in the outside surface of the first smooth pipe commensurately with placing a concave dimple in the outside of the reducer, while commensurately placing a concave dimple in the outside surface of the second smooth pipe.

### BRIEF DESCRIPTION OF THE DRAWINGS

FIG. 1 is a full side view of a section of smooth pipe showing the metal adjustable fitting on the surface thereof.

FIG. 2 is full end view of the adjustable fitting.

FIG. 3 is a full top view of the fitting of FIG. 2.

FIG. 4 is full side view of a coupling of this invention connecting two end sections of smooth pipe together.

FIG. 5 is a full side view of a reducer of this invention and two different sized pipes fox connection.

FIG. 6 is a full side view of an elbow of this invention.

FIG. 7 is a tee for piping made from an adjustable fitting of this invention and a portion of pipe.

### DETAILED DESCRIPTION OF THE INVENTION

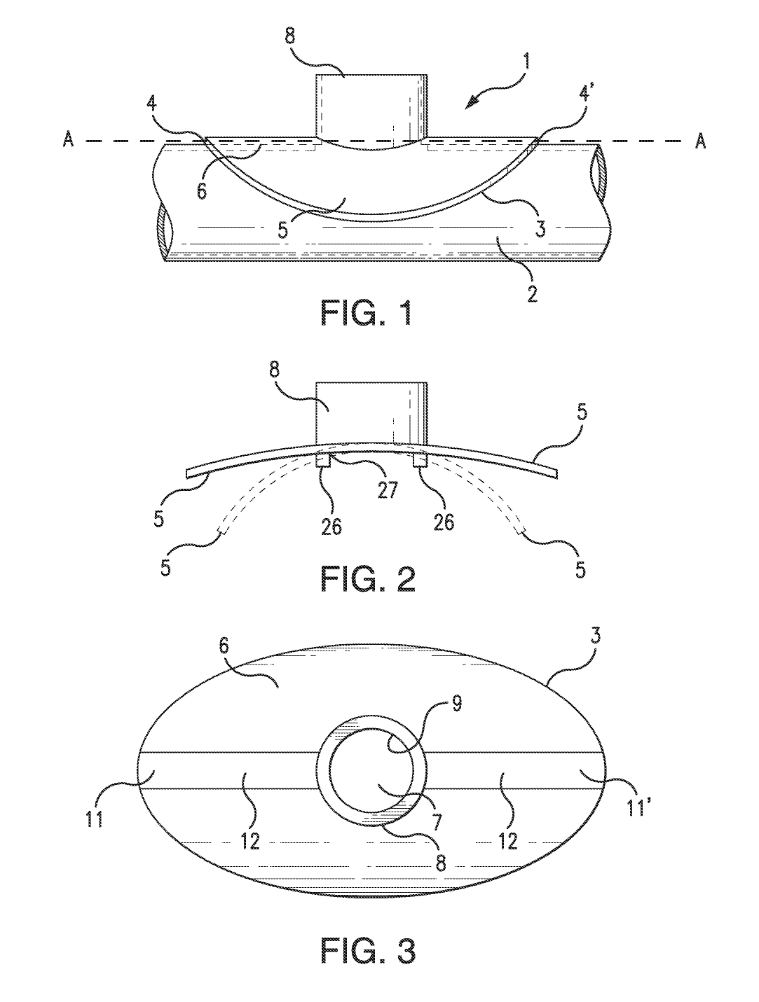

Turning now to FIG. 1, wherein there is shown a full side view of a section of smooth pipe 2 showing the adjustable fitting 1 on the surface of the pipe 2.

To those skilled in the art, it is known that there is an opening in the pipe 2 (not shown) that the adjustable fitting 1 is covering. The adjustable fitting 1 is integral and malleable and is comprised of a malleable saddle-configured base 3 having a linear axis A-A, two terminal ends 4 and 4′, two lateral wings 5 (only one of which is shown), a top surface 6 and a centered opening 7 therethrough (see FIG. 3).

There is a hollow hub 8, centered and surmounted over said-centered opening 7. The hollow hub 8 has an inside surface 9 (See FIG. 3), and a bottom edge 10. The inside surface 9 of the hub can be smooth, for the use of adhesives, or can be dimpled as will be described infra, or can be threaded for standard pipe sizes. The hub 8 has a lower bottom edge 27 and it is contemplated within the scope of this invention to have tabs 26 located on this bottom edge that they can insert into notches formed in the opening of a pipe, so as to prevent the adjustable fitting 1 from turning on the surface of the pipe.

There are two, rigid stabilizer ridges 11 and 11′ located on the top surface 6 of the base 3. Each of the said stabilizer ridges 11 and 11′ have a top flat surface 12, and extend along the linear axis A-A of the saddle-configured base 3, from the hub 8 to a terminal end 4 or 4′. These rigid stabilizer ridges 11 and 11′ act as reinforcement for the adjustable fitting 1. The hub 8 is for connecting additional piping at this juncture in the pipe 2.

The opening width of the saddle of the saddle-based configuration 3 is enough to allow for the adjustable fitting 1 to fit over a large pipe. Upon fitting the adjustable fitting 1 to a pipe, the two lateral wings 5 are hammered or squeezed down onto the surface of the pipe 2 such that the saddle fits the surface tightly. Thus, the adjustable fitting can be used on all sizes of pipe. Once fitted to the pipe, the adjustable fitting is adhered to the pipe surface with a metal-adhesive. FIG. 2 shows an end view of the adjustable fitting 1 of this invention wherein there is also shown a bend of the lateral wings 5 in phantom to illustrate how the lateral wings 5 can be bent down to the surface of the pipe.

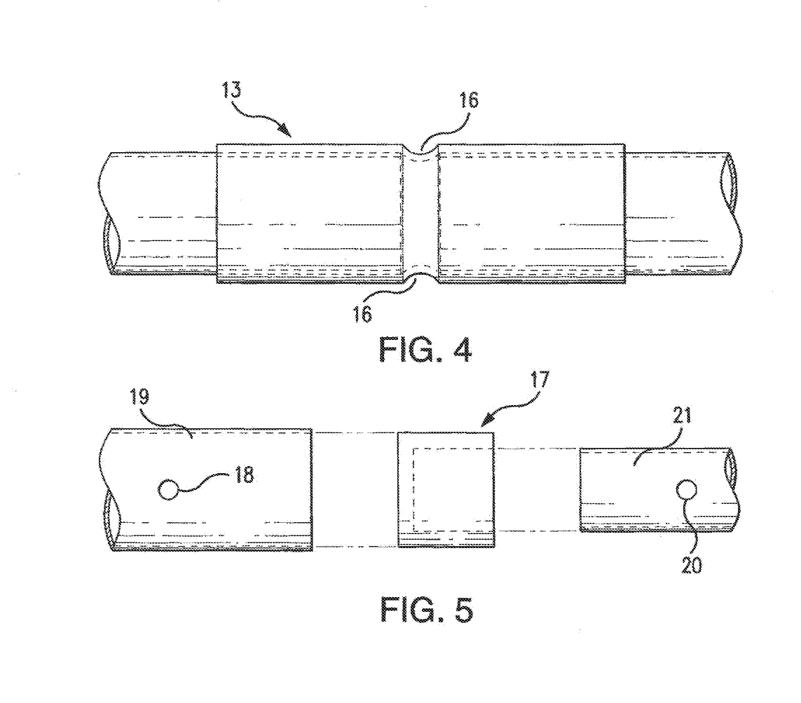

This invention contemplates a coupling 13 as shown in FIG. 4. The coupling 13 is shown as joining two segments of pipe P wherein there is also shown stop dimples 14. Stop dimples 14 formed in the coupling 13 allow for stopping the insertion, of the pipe ends 15 beyond a certain point. Also shown is a stabilizer dimple 16 (See U.S. Pat. No. 5,827,723) which is incorporated herein by reference for showing the means by which pipe dimpling can be accomplished. This dimple 16 disallows the turning, or moving of the pipe otherwise, in the connector 13. This coupling 13 is also connected to piping using a metal adhesive.

Also contemplated within the scope of this invention is a pipe reducer 17, shown in FIG. 5. This reducer 17 does not have any dimpling, but is fitted by dimpling the pipes in which it is to be used. For example, there is a dimple 18 in the large pipe 19 shown in FIG. 5 and a dimple 20 shown in the small pipe 21 in FIG. 5. The dimple 20 in the small pipe 21 is facing out rather than in as are the stop dimples such as 16. This dimple 21 is formed by using a dimpling device and putting it inside of the pipe rather than, on the outside of the pipe.

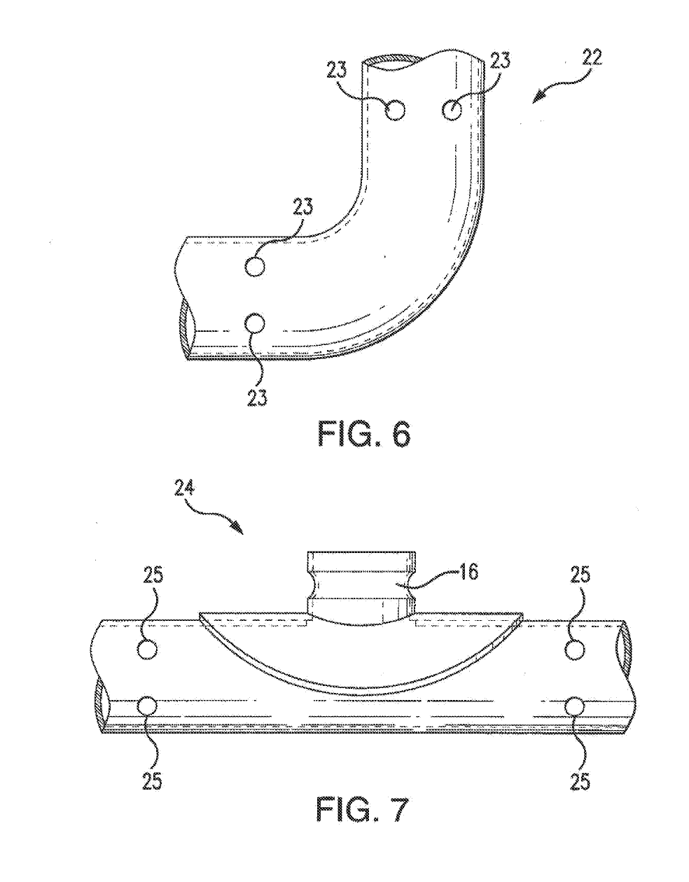

Shown in FIG. 6 is an elbow 22 in which there is shown retainer dimplings 23. FIG. 7 shows a pipe tee 24 that has an adjustable fitting 1 mounted on it and retainer dimplings 25. Retainer dimplings are used to retain the fittings and pipe together with the use of a metal adhesive.

What is claimed is;

1. An adjustable fitting for smooth pipe, said adjustable fitting comprising an integral combination of:
(i) a malleable saddle-configured base having a linear axis, terminal ends, two lateral wings, a top surface and a centered opening therethrough;
(ii) a hollow hub centered and surmounted over said centered opening, said hollow hub having an inside surface and a bottom edge;
(iii) two stabilizer ridges located on said top surface of said base, each said stabilizer ridge having a top, flat surface, and extending along said linear axis of said saddle-configured base from said hub to a terminal end of said saddle-configured base.

2. The adjustable fitting as claimed in claim 1 wherein said inside surface of said hub is smooth.

3. The adjustable fitting as claimed in claim 1 wherein said inside surface of said hub is threaded.

4. The adjustable fitting as claimed in claim 1 wherein, in addition, there are tabs located on said, bottom edge of said hub, said tabs extending below said bottom edge of said hub.

5. A coupling for smooth pipe, said coupling being a hollow tube with a center point;
said coupling having at least one concave dimple at said center point;
said coupling having an inside diameter for accepting smooth pipe in a close, sliding fit.

6. In combination, an adjustable fitting as claimed in claim 1 and a coupling, said coupling being a hollow tube with a center point and two ends;
said coupling having at least one concave dimple at said center point;
said coupling having an inside diameter for accepting smooth pipe in a close, sliding fit.

7. The combination as claimed in claim 6 wherein said coupling has at least one concave dimple at a predetermined distance from each end.

8. A smooth pipe elbow, said smooth pipe elbow having two ends and a circular wall extending therebetween, said smooth pipe elbow having at least one concave dimple in said wall at a predetermined distance from each said end.

9. In combination, a coupling of claim 5 and smooth pipe, wherein said coupling and said smooth pipe are connected together with a metal adhesive.

10. In combination, an elbow as claimed in claim 8, smooth pipe, and an adhesive for connecting said elbow and said smooth pipe together.

11. In combination, a coupling as claimed in claim 5, smooth pipe, an adjustable fitting, said adjustable fitting comprising an integral combination of:
(a) a saddle-configured base having a linear axis, terminal ends, two lateral wings, a top surface and a centered opening therethrough;
(b) a hollow hub centered and surmounted over said centered opening, said hollow hub having an inside surface and a bottom edge;
(c) two stabilizer ridges located on said top surface of said base, each said stabilizer ridge having a top, flat surface, and extending along said linear axis of said saddle-configured base from said hub to a terminal end of said saddle-configured base, and,
(d) a means of connecting said coupling, said smooth pipe, and said adjustable fitting together.

12. In combination,
(i) a first smooth pipe having two ends, an inside diameter, an outside diameter and an outside surface, said first smooth pipe having a concave dimple located near at least, one end of said first smooth pipe, each said dimple being located a predetermined distance from each said end;
(ii) a pipe reducer, said pipe reducer having an outside surface, an outside diameter less than said, inside diameter of said first smooth pipe and an inside diameter, being slidably acceptable into a second smooth pipe having a diameter less than said inside diameter of said first smooth pipe;
(iii) a second smooth pipe having an outside surface and being lesser in diameter than said first smooth pipe and slidably insertable into said pipe reducer, said second smooth pipe having a concave stop dimple located on an outside surface a predetermined distance from an end of said second smooth pipe, said (i), (ii) and (iii) being connected and fixed together by an adhesive.

13. A method of manufacturing the combination as claimed in claim 12, said method comprising:
A. treating said outside surface of said reducer near one end with an adhesive;
B. treating said outside surface of said second smooth pipe near one end with an adhesive;
C. fitting said first smooth pipe, said reducer, and said second smooth pipe together;
D. placing a securing concave dimple in said outside surface of said first smooth, pipe commensurately with placing a concave dimple in said outside of said reducer, while commensurately placing a concave dimple in said outside surface of said second smooth pipe.
